(19) United States
(12) Patent Application Publication
(10) Pub. No.: US 2012/0262289 A1
(43) Pub. Date: Oct. 18, 2012

(54) SECURITY SYSTEMS HAVING PORTABLE MONITORING DEVICES AND METHODS USING SAME

(76) Inventors: Kenneth Robert French, II, Harrison, OH (US); Angela Ann Huber, Aurora, IN (US); Thomas Paul Rebel, Wilder, KY (US); Gary L. Uthe, Fort Wright, KY (US)

(21) Appl. No.: 13/437,551

(22) Filed: Apr. 2, 2012

Related U.S. Application Data
(60) Provisional application No. 61/469,952, filed on Mar. 31, 2011.

(51) Int. Cl. G08B 1/08

(52) U.S. Cl. 340/539.11

(57) ABSTRACT

A security system having a portable monitoring device in communication with detection devices and notification systems to provide messages. Methods for employing a portable monitoring device are also provided herein.

### REFERENCE TO RELATED APPLICATION

The present application claims priority of U.S. provisional application Ser. No. 61/469,952, filed Mar. 31, 2011, and hereby incorporates the same application herein by reference in its entirety.

### TECHNICAL FIELD

A portable monitoring device for a security system to monitor an environment and provide an alert upon receipt that a particular action has been detected.

### BACKGROUND

Monitoring and alert systems have become important and necessary tools for business owners and residents to provide adequate security and offer a sense of safety. People have adopted many solutions to provide added security to protect assets, property and themselves. As such, providing a security system which provides remote monitoring, portability and flexible security features would be of great benefit to those seeking additional and/or alternative security options.

### SUMMARY

In accordance with one embodiment, a security system comprising a portable monitoring device, at least one detection device, and at least one notification device. The portable monitoring device comprises a user interface. The user interface comprises at least one operative input and at least one scheduled input. The operative input is associated with a first indicator and the scheduled input is associated with a second indicator. The first indicator and the second indicator inform a user whether the inputs are active. The operative input is associated with the detection device. The notification device is configured to communicate with the portable monitoring device. A predetermined message is transmitted from the portable monitoring device to the notification device upon activation of the said detection device.

In accordance with another embodiment, a portable monitoring device for a security system comprises a console unit having an upper portion and a lower portion. The upper portion comprises a user interface. The user interface comprises at least one operative input and at least one scheduled input. The operative input is associated with a first command and the scheduled input indicates when the first command is active.

In accordance with yet another embodiment, a user interface for a portable monitoring device for a security system comprising at least one operative input and at least one scheduled input. The operative input is associated with a first command and the scheduled input indicates when the first command is active.

In accordance with still another embodiment, a method of securing an environment, the method comprising locating at least one detection device at a predetermined location within an environment; positioning a portable monitoring device within the environment; and communicating a message from the portable monitoring device to at least one notification device upon activation of said detection device. The portable monitoring device is in communication with the detection device and the monitoring device comprises a user interface. The user interface comprises at least one operative input and at least one scheduled input. The operative input is associated with a first indicator and the scheduled input is associated with a second indicator. The first indicator and the second indicator inform a user whether such inputs are active.

In accordance with still yet another embodiment, a method of monitoring an environment, the method comprising positioning a portable monitoring device within an environment. The portable monitoring device comprises a user interface. The user interface comprises at least one operative input and at least one scheduled input. The method further comprises selecting at least one detection device to monitor via said operative input; scheduling a predetermined period to monitor said detection device via said scheduled input; and alerting at least one notification device with a message received from the monitoring device during the predetermined period. The message includes the location of the environment and a pre-selected warning.

### BRIEF DESCRIPTION OF THE DRAWINGS

It is believed that certain embodiments will be better understood from the following description taken in conjunction with the accompanying drawings in which:

FIG. 1 is a schematic view depicting a general representation of a security system;

FIG. 2 is a perspective view depicting a console of a monitoring device for a security system; and

FIG. 3 is a top view depicting a user interface of the console of FIG. 2.

### DETAILED DESCRIPTION

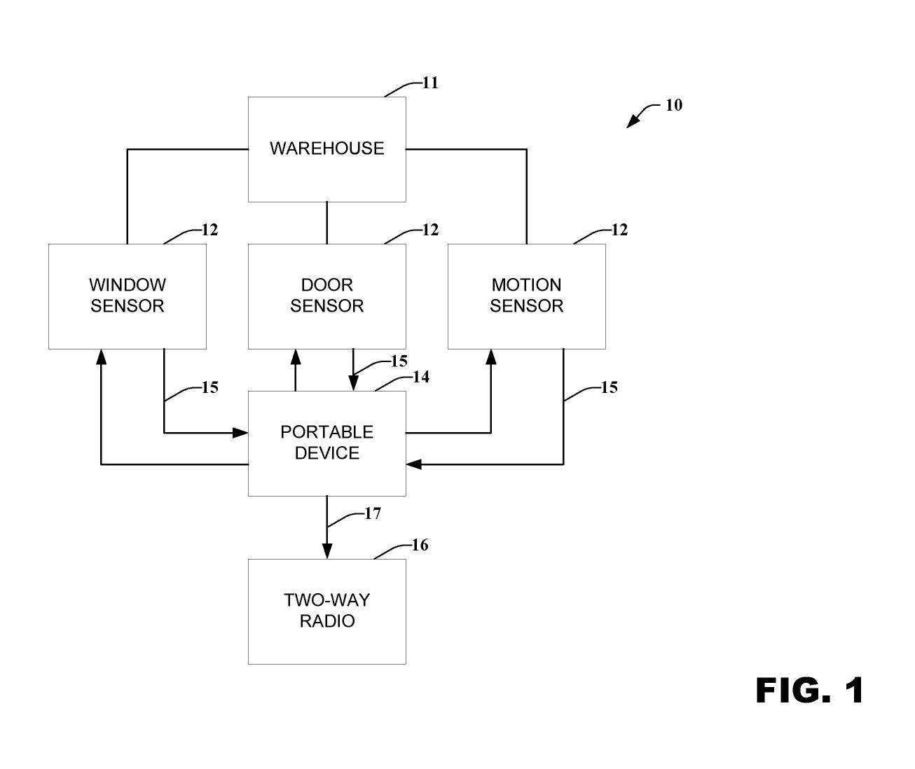

Selected embodiments are hereinafter described in detail in connection with the views and examples of FIGS. 1-3.

Security systems have become important and necessary tools for business owners and residents to provide adequate security and offer a sense of safety. Multiple solutions have been adopted to provide added security to protect assets, property and themselves. Such security systems can be employed in homes, schools, medical facilities, courthouses, retail locations, warehouses, industrial sites, casinos, or any other suitable location. However, there remains a need to have a monitoring system which provides sufficient flexibility to monitor and protect such locations with remote capabilities and simple ease of use.

A security system 10 in accordance with one embodiment is generally depicted in FIG. 1. The security system 10 can include one or more detection devices 12 (e.g., sensors), a monitoring device 14 in communication with the one or more detection devices 12, and one or more notification devices 16 (e.g., phones, two-way radios, etc.) to observe and protect an environment 11 (e.g., home, church, warehouse, store, etc.). As generally depicted in FIG. 1, the monitoring device 14 can be in communication with the one or more detection devices 12 to determine if such detection devices are activated. For example, if a detection device 12 (e.g., a motion detector) senses movement within an environment 11 (e.g., industrial site), the detection device 12 communicates with the monitoring device 14 by sending a signal 15, so that the monitoring device 14 can, in turn, communicate and transmit a signal 17, including predetermined information, to an alarm notification device 16 (e.g., police two-way radio). It will be appreciated that a number of different types of detection devices can be employed as part of a security and alert system. For example, such detection devices can include car counters, door/window transmitters, duress buttons, glass break detection transmitters, motion activated digital cameras, tilt switches, motion detectors, pressure mats, smoke detector transmitters, temperature transmitters, trip beams, universal transmitters, water detection devices, and any other suitable detection devices or combination thereof. Because a security and alert system as described herein can incorporate a variety of detection devices, in both type and number, this provides added flexibility to the user relying on the security system for protection. For example, if a business owner wants to continuously monitor various locations within a particular environment, like a store, a security system could utilize different types of detection devices, located at various locations (e.g., at each door and each window), which can then all be tied to and be in communication with a single monitoring device.

Detection devices can communicate with a monitoring device in a number of suitable ways. In certain embodiments, such communication can occur wirelessly with the monitoring device (e.g., via radio communication). As such, a monitoring device can communicate with detection devices in a wireless environment allowing for the monitoring device to be portable, thus providing flexibility to the user to place the monitoring device in any number of a variety of locations within an environment (e.g., property or location). For example, if a business owner had multiple store locations, he/she could use the same monitoring device and transport it between store locations. The portability of a monitoring device and its ability to interact with various types of detection devices provides a solution to users who wish to provide increased security at various locations while reducing the need and costs associated with maintaining full-time security at each and every location.

As generally depicted in FIG. 1, once the monitoring device 14 receives a communication from the one or more detection devices 12 indicating activation of a particular detection device 12, the monitoring device 14 can then communicate with one or more notification devices 16 to transmit a message and/or alert (e.g., an email). Such communication between the monitoring device 14 and such notification devices 16 can occur in a wireless environment (e.g., via Bluetooth®). It will be appreciated that a number of different types of notification devices can be employed as part of a security or monitoring system described herein. For example, notification devices can include two-way radios, phones (landline or mobile), pagers, and any other suitable voice/audio/text capable devices. Messages provided to such notification devices can take the form of alarms, calls, emails, pages, and any other suitable voice, audio and/or textual message. For example, a message could broadcast to a police officer's two-way radio and repeat the phrase, “BREAK-IN OCCURING AT 123 APPLESEED DRIVE, RESPOND IMMEDIATELY.” It is contemplated that a message sent to a notification device can be received by the notification device during a short time interval. For example, in certain embodiments a notification device can receive the message in less than about 5 seconds; in certain embodiments in less than about 3 seconds; and in certain embodiments in less than about 1 second. It is also contemplated that such messages or alerts can be broadcast over multiple channels or frequencies; and/or can be repeated in regular intervals, so as to insure receipt of the message.

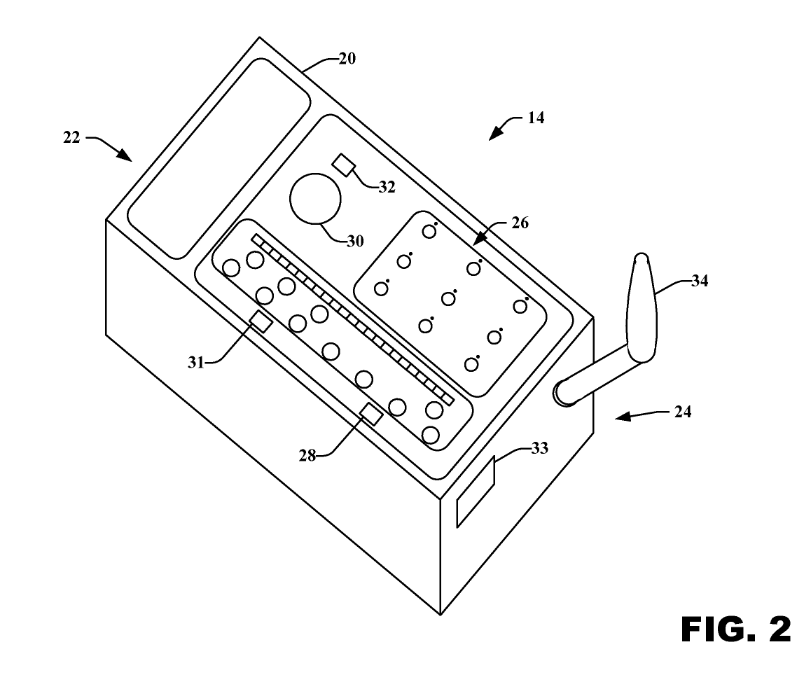

The monitoring device 14 generally depicted in FIG. 1 can be configured to have a number of configurations. In one embodiment, the monitoring device 14 can include a console unit 20, as depicted in FIG. 2. The console unit 20 can include an upper portion 22 and a lower portion 24. The upper portion 22 can include a user interface 26, a microphone 28, a speaker 30, a power indicator 32 (e.g., battery power charging status and A/C power source) and at least one digital communication port 31 (e.g., USB port connector). The lower portion 24 can include at least one power outlet 33 (e.g., A/C receptacle outlet, D/C connector outlet, and/or relay connector) and a radio receiver (e.g., antenna 34) for receiving wireless communications (e.g., radio transmissions) from such detection devices as described herein and/or transmitting messages to a notification device 16. In certain embodiments, the console unit 20 can be powered via either internal or external power sources (e.g., an A/C source and/or a battery). In certain embodiments, while a console unit is powered by an external power source, an internal power source can also be charging during the same time. It will be appreciated that a digital communication port can be configured to permit a user to upgrade any software or firmware associated with a monitoring device. Further, it can be contemplated that the at least one digital communication port can be configured to permit the user to download data stored on a monitoring device such as could be associated with a data log, including any communications, associated with the use of the monitoring device. Such data log can include information relating to sensor activation, missing sensors, sensor tampering, and battery notifications for sensors and any other suitable data entry information which may be relevant to the monitoring of a security system.

In certain embodiments, a monitoring device can be connected (wired or wirelessly) to a general purpose computer (e.g., computer, laptop, tablet, server, etc.) via the digital communication port 31. In one embodiment, the general purpose computer can facilitate viewing of historical records associated with environments monitored and secured by the monitoring device. In certain embodiments, a monitoring device could be actively controlled via a remote source (e.g., general purpose computer), whereby the commands and inputs could be selectively modified. For example, while connected to such a general purpose computer, the general purpose computer can access software associated with operative inputs and scheduled inputs (as further discussed below) to permit a user to remotely program the commands for the monitoring device as opposed to on-board programming of the commands by physically activating capacitive touch keys associated with the operative inputs and scheduled inputs.

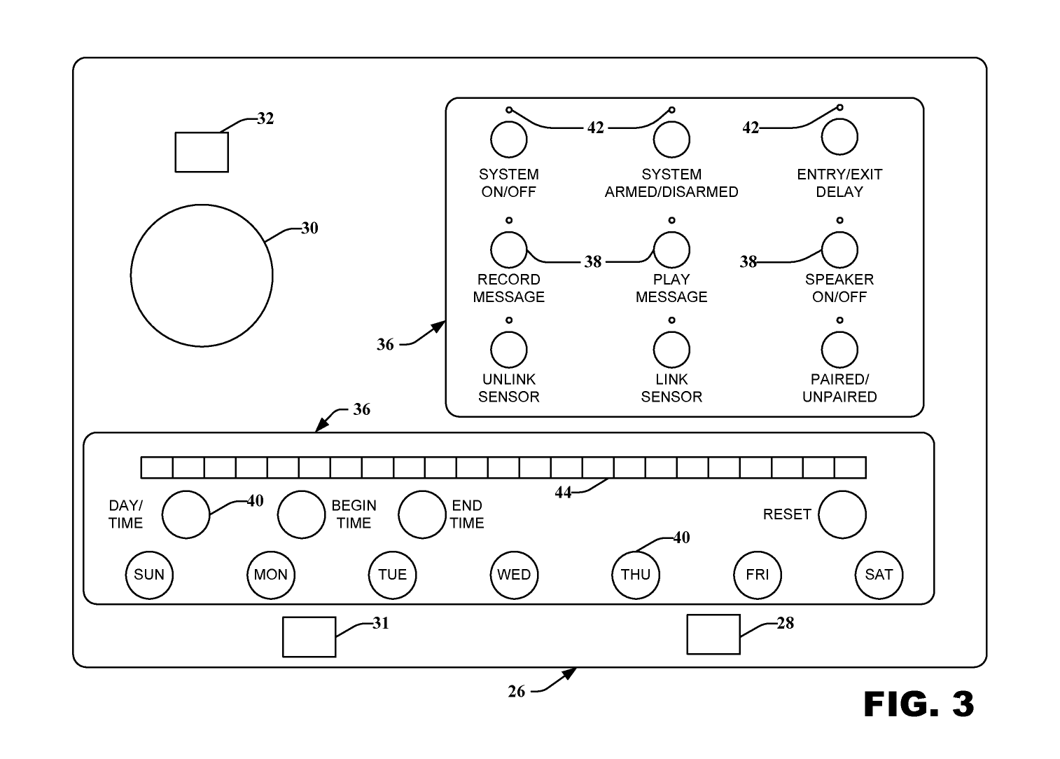

As further illustrated in FIG. 3, the user interface 26 can include capacitive touch keys 36 (including, for example, operative inputs 38 and time scheduled inputs 40), which can include a variety of system indicators allowing the user to activate various components and provide commands via the user interface 26. For example, the capacitive touch keys 36 can include such operative inputs 38 as a SYSTEM ON/OFF key, a SYSTEM ARMED/DISARMED key, an ENTRY/EXIT DELAY key, a RECORD MESSAGE key, a PLAY MESSAGE key, a SPEAKER ON/OFF key, an UNLINK SENSOR key, a LINK SENSOR key, a PAIRED/UNPAIRED key (this can be used with Bluetooth® compatible devices), or any other suitable operative inputs. Each of these operative inputs 38 (shown in FIG. 3) can be actuated to perform a designated action. The operative inputs 38 can include respective indicators (e.g., LEDs 42) that indicate to the user whether or not the particular operative input 38 has been engaged and activated. For example, if a SYSTEM ON/OFF key shows an LED 42 that is lit green, then the system is ON, but if the LED 42 is not lit or the LED 42 is lit red, then the system is OFF. It will be appreciated that a variety of indicator arrangements could be used to indicate to the user when a particular operative input has been activated (e.g., use of different LED colors or when the LED is lit or not lit). In another embodiment, one operative input 38 identified as the LINK SENSOR key and the UNLINK SENSOR key (depicted in FIG. 3) can allow the user to specifically designate which detection devices as described herein are linked to a monitoring device and which are not. In another embodiment, one operative input 38 identified as the ENTRY/EXIT DELAY can allow the user to delay activation of detection devices. Such methods to delay the activation of various operative inputs can include providing sufficient time (e.g., about 90 seconds) for a user to activate the monitoring system (e.g., “arming” the system) and remove themselves from the environment before accidentally activating the monitored detection device.

In addition to the operative inputs 38, the capacitive touch keys 36 can further include scheduled inputs 40 which allow a user to specifically designate when (and for how long) a particular action associated with a particular operative input 38 may be activated. For example, a SYSTEM ARMED/DISARMED key may be activated from Friday at 5:00 pm to Monday at 8:00 am, so that during this time a security system is actively monitoring designated detection devices during that particular time period (e.g., when a business is closed over a weekend). Then on Monday at 8:01 am, the SYSTEM ARMED/DISARMED key can be deactivated and the security system is no longer active. It will be appreciated that time of day can also be identified in military time increments 44 (e.g., 1800 hours).

The microphone 28 and the speaker 30 can each be configured to permit recording of voice messages and playback through use of designated operative inputs 38. In one embodiment, a speaker can be used as an output device which allows the user the select and prioritize the speaker to be used for output of audio as well as volume control. For example, a speaker can provide a verbal response to the user informing the user whether a specific operative input is active. In one embodiment, operative input can include providing a specified message to transmit to a notification device in the event of a breach of security. For example, a user can verbally record (via the microphone 28) a desired message via an operative input, and/or play a message to listen to (via the speaker 30) and determine if such message conveys the information desired by the user. When a detection device is activated, the speaker 30 can emit an audible warning that notifies the surrounding environment that a detection device has been activated.

In certain embodiments, the power indicator 32 can include a battery power charging status indictor having associated LEDs. In certain embodiments, these LEDs can vary in color to indicate to the user how much power remains in an internal battery source (not shown). For example, when the LEDs are green, the battery power source can have about a 99% power level, when yellow, the battery power source can have about a 66% power level, and when red, the battery power source can have about a 33% power level. It will be appreciated that other indicator configurations could be used to indicate to a user the amount of power remaining for a respective battery power source.

The console unit 20, as illustrated in FIG. 2, can be configured to rest in a casing (e.g., Pelican™ case). Such casing can provide additional protection and support to the console unit 20, preventing damage or accidental activation/deactivation of the console unit 20. For example, a console unit of the monitoring device may be stored and locked in the casing during transport and/or use. For ease of transport, such a casing can include a handle or any other suitable arrangement to permit easy transport of a monitoring device. Furthermore, such a casing may have requisite openings to permit cables or cords (e.g., power cords) to pass through the casing and connect to a monitoring device. In certain embodiments, a casing can be integral or independent of a console unit. It will also be appreciated that such casings may have various shapes, styles, and configurations as may be suitable to provide flexibility to the use of a monitoring device.

The foregoing description of embodiments and examples has been presented for purposes of illustration and description. It is not intended to be exhaustive or limiting to the forms described. Numerous modifications are possible in light of the above teachings. Some of those modifications have been discussed and others will be understood by those skilled in the art. The embodiments were chosen and described for illustration of various embodiments. The scope is, of course, not limited to the examples or embodiments set forth herein, but can be employed in any number of applications and equivalent devices by those of ordinary skill in the art. Rather it is hereby intended the scope be defined by the claims appended hereto.

What is claimed is:

1. A security system comprising:
a) a portable monitoring device comprising a user interface, wherein the user interface comprises at least one operative input and at least one scheduled input, wherein said operative input is associated with a first indicator and said scheduled input is associated with a second indicator, wherein the first indicator and the second indicator inform a user whether said inputs are active;
b) at least one detection device, wherein said operative input is associated with said detection device; and
c) at least one notification device, wherein said notification device is configured to communicate with the portable monitoring device, wherein a predetermined message is transmitted from the portable monitoring device to the notification device upon activation of said detection device.

2. The security system of claim 1, wherein said operative input comprises one or more of a SYSTEM ON/OFF key, a SYSTEM ARMED/DISARMED key, an ENTRY/EXIT DELAY key, a RECORD MESSAGE key, a PLAY MESSAGE key, a SPEAKER ON/OFF key, an UNLINK SENSOR key, a LINK SENSOR key, a PAIRED/UNPAIRED key, and combinations thereof.

3. The security system of claim 1, wherein the first indicator and the second indicator comprise LEDs.

4. The security system of claim 1, wherein the portable monitoring device is stored in a casing.

5. The security system of claim 1, wherein said scheduled input comprises a particular day of the week.

6. The security system of claim 1, wherein said scheduled input comprises a particular time period.

7. The security system of claim 1, wherein said detection device comprises one or more of a car counter, a door/window transmitter, a duress button, a glass break detection transmitter, a motion activated digital camera, a tilt switch, a motion detector, a pressure mat, a smoke detector transmitter, a temperature transmitter, a trip beam, a universal transmitter, a water detection device, and combinations thereof.

8. The security system of claim 1, wherein said notification device comprises one or more of a two-way radio, a phone, a pager, and combinations thereof.

9. The security system of claim 1, wherein the predetermined message is transmitted to the notification device in less than about 5 seconds.

10. The security system of claim 1, wherein the system is located at a particular environment.

11. The security system of claim 10, wherein the predetermined message comprises a specific warning and provides the location of the environment.

12. A portable monitoring device for a security system, the portable monitoring device comprising a console unit having an upper portion and a lower portion, the upper portion comprising a user interface, the user interface comprising at least one operative input and at least one scheduled input, wherein said operative input is associated with a first command and said scheduled input indicates when the first command is active.

13. A user interface for a portable monitoring device for a security system, the user interface comprising at least one operative input and at least one scheduled input, wherein said operative input is associated with a first command and said scheduled input indicates when the first command is active.

14. A method of securing an environment, the method comprising:
a) locating at least one detection device at a predetermined location within an environment;
b) positioning a portable monitoring device within the environment, wherein the portable monitoring device is in communication with said detection device and the portable monitoring device comprises a user interface, wherein the user interface comprises at least one operative input and at least one scheduled input, wherein said operative input is associated with a first indicator and said scheduled input is associated with a second indicator, wherein the first indicator and the second indicator inform a user whether such inputs are active; and
c) communicating a message from the portable monitoring device to at least one notification device upon activation of said detection device.

15. A method of monitoring an environment, the method comprising:
a) positioning a portable monitoring device within an environment, wherein the portable monitoring device comprises a user interface, wherein the user interface comprises at least one operative input and at least one scheduled input;
b) selecting at least one detection device to monitor via said operative input;
c) scheduling a predetermined period to monitor said detection device via said scheduled input; and
d) alerting at least one notification device with a message received from the portable monitoring device during the predetermined period, wherein the message includes the location of the environment and a pre-selected warning.
